(19) United States
(12) Patent Application Publication
(10) Pub. No.: US 2004/0017314 A1
(43) Pub. Date: Jan. 29, 2004

(54) Dual band directional antenna

(75) Inventor: Athanasios Petropolous, Chicago, IL (US)

Correspondence Address: BABCOCK IP LLC, 24154 LAKESIDE DRIVE, LAKE ZURICH, IL, 60047, US

(73) Assignee: Andrew Corporation, Orland Park, IL (US)

(21) Appl. No.: 10/064,594

(22) Filed: Jul. 29, 2002

(51) Int. Cl. H01Q 1/38

(52) U.S. Cl. 343/700 MS

(57) ABSTRACT

A dual band antenna having a base plate, an RF structure forming dipole antenna elements and a radiator forming a patch antenna. The RF structure coupled with the base plate, the radiator having a slot, the radiator located in a substantially parallel orientation with and electrically isolated from the base plate and the RF structure; a dipole portion of the RF structure extending through the slot so that the radiator also acts as a ground plane for the dipole antenna elements.

### BACKGROUND OF INVENTION

1. Field of the Invention

The invention relates to antennas. More specifically, the invention relates to an inexpensive to manufacture directional dual band antenna, for example, suitable for in-building or microcell applications.

2. Description of Related Art

Cellular telephones commonly use one of a low frequency band, for example 824-890 Megahertz, and a high frequency band, for example 1.70-2.17 Gigahertz. Dual band antennas avoid the costs associated with providing a discrete antenna for each band. To provide wireless coverage, for example in a single room or for a floor of a building, wall mounted directional antennas may be desirable.

Patch antennas may be configured with induced coupling to operate in a fundamental TM10 excitation mode to produce a relatively narrow radiation pattern. Normally consisting of a planar antenna element spaced away from a ground plane, patch antennas have used a stacked construction to obtain multiple band operation.

Dipole antennas, normally dimensioned for ½ wavelength of the middle of a target band have a radiation pattern that is strongest at right angles to the dipole elements. A dipole antenna may be made directional by placing a conductive parasitic element, for example a ground plane, at a location where radiation is undesired. Multiple band dipole antennas using multiple ½ wavelength dipole elements, sized for desired bands often have undesired harmonics and mutual inductance.

Competition within the antenna industry has focused attention on minimization of materials and manufacturing process costs.

Therefore, it is an object of the invention to provide an antenna, which overcomes deficiencies in the prior art.

### BRIEF DESCRIPTION OF DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is an exploded isometric view of a first embodiment of the invention.

FIG. 2 is an exploded isometric view of antenna elements of a first embodiment of the invention.

FIG. 3 is a first side view of the RF structure of a first embodiment of the invention.

FIG. 4 is a second side view of the RF structure of a first embodiment of the invention.

FIG. 5 is a top view of the radiator of a first embodiment of the invention.

FIG. 6 shows test performance data for standing wave ratio with respect to frequency of the first embodiment.

FIG. 7 shows test performance data for the radiation pattern at a low band representative frequency of the first embodiment.

FIG. 8 shows test performance data for the radiation pattern at a high band representative frequency of the first embodiment.

### DETAILED DESCRIPTION

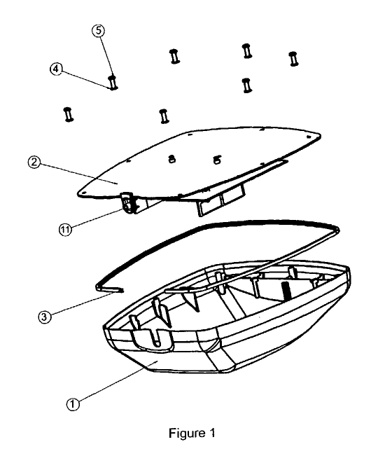

A first embodiment, as shown in FIG. 1, may have a cover 1 that encloses antenna elements. The cover 1 may be shaped to create an environmental seal against a base plate 2, isolating the antenna elements and circuitry from water and other contaminant infiltration. A sealing adhesive and/or a gasket 3 may be used to improve the environmental sealing integrity. The base plate 2 may be metal or metal alloy, for example aluminum, formed for example, by die-casting or cutting/stamping from stock plate material. Alternatively, the base plate 2 may be formed as a conductive trace on an insulating substrate, for example a printed circuit board. The cover 1 may be formed, for example, by injection molding using a RF transmissive insulating material, such as polycarbonate, acrylic or other plastic material. The cover may be closed by, for example, a snap fit and or one or more screws 4. The screw(s) 4 may also have individual sealing/insulating washers 5.

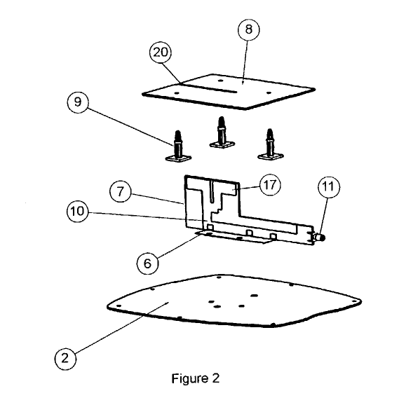

Antenna elements, as shown in FIG. 2, may be mounted on the base plate 2. An angle plate 6 may be used to support an RF structure 7 at a desired angle to the base plate 2, for example 90 degrees. The RF structure 7 may be formed out of an insulating substrate, for example a printed circuit board, with first and second electrical conductors located on first and second sides. Alternatively, the first and second side conductors may be located on a common side of the insulating substrate, electrically insulated from each other, for example in different conductive layers on the insulating substrate.

A radiator 8 may be located, for example, in a parallel orientation spaced away from the base plate 2 by, for example, one or more dielectric spacers 9.

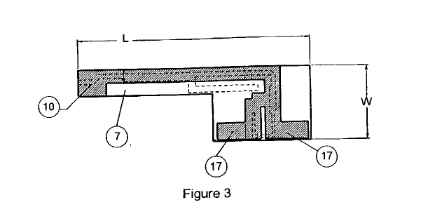

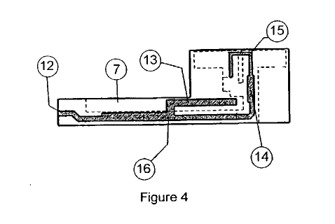

A conductor 10 acting as a ground plane, on a first side of the RF structure 7, as shown in FIG. 3, may be electrically coupled via the angle plate 6 to the base plate 2. An antenna connector 11, for example a co-axial connector, may have a shield side coupled to the conductor 10 on the first side of the RF structure 7 and a center conductor coupled to a feed conductor 12 located, for example on a second side of the RF feed structure 7, as shown in FIG. 4. Feed conductor 12 in conjunction with conductor 10 forms a microstrip line that transfers RF power supplied to the antenna via connector 11 to radiator element 8 and dipole elements 17 (to be described).

The feed conductor 12 couples an RF receiver and or transmitter, via for example antenna feed connector 11, to high band and low band radiator elements of the antenna that are tuned to resonate at target high and low frequency bands respectively. Target bands may include cellular telephone frequency bands, for example AMPS or GSM as low band, and for example UMTS or PCN as high band. By tuning the impedance characteristics of the feed conductor 12, low and high band RF currents may be directed to split into the desired high and low band radiator elements of the antenna.

An L-probe 13 portion and a matching section 14 of the feed conductor 12 create a band discriminating impedance match whereby at a junction 16 low band RF currents may see, for example, a 50 ohm impedance going towards the L-probe 13 and a very high impedance going towards the matching section 14. Conversely, high band RF currents may see, for example, a 50 ohm impedance going towards the matching section 14 and a very high impedance going towards the L-probe 13.

Matching section 14 may be configured to have a ¼ wavelength dimension with respect to the middle of the desired frequency band, in this case the high band. A ¼ wavelength (high band) balun 15 coupled to the matching section 14 may be used to impedance transfer the high band RF currents to, for example, ½ wavelength (high band) dipole elements 17 located, for example, on the first side of the RF structure 7 (FIG. 3). The dipole elements 17 may be coupled by the conductor 10 to the base plate 2 and the shield side of the antenna feed connector 11.

To minimize materials costs, the RF structure 7 may be formed with dimensions only as large as required to support the desired conductor 10 and feed conductor 12, for example a length L of 165 millimeters and a width W of 53 millimeters, in an L-shaped configuration.

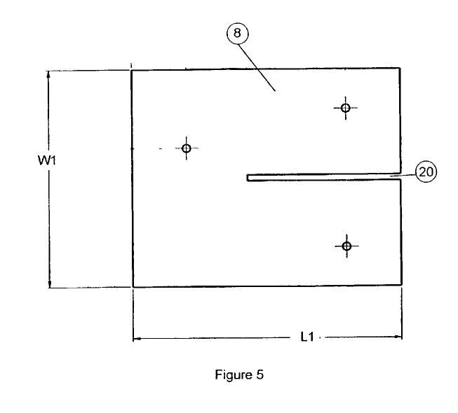

The radiator 8, as shown in FIG. 5, is dimensioned as a microstrip patch radiator for the low band. The radiator 8 may be metal or metal alloy, for example aluminum, formed for example, by die-casting or cutting/stamping from stock plate material. Alternatively, the radiator 8 may be formed as a conductive trace on an insulating substrate, for example a printed circuit board. The L-probe 13 couples RF energy to radiator 8. An opening, for example slot 20 allows the radiator 8 to be located surrounding the portion of the RF structure 7 containing the dipole elements 17, aligned in proximity to the L-probe 13 from which the radiator 8 couples low band RF currents. The radiator 8 has a length L1 that may be configured to have a ½wavelength (low band) dimension with respect to the middle of a desired frequency band. The radiator 8 may radiate in a directional TM10 mode. To aid TM10 mode operation, the slot 20 may be aligned to interfere with RF currents of other modes by being positioned parallel to the length L1. The slot 20 is dimensioned to accept the RF structure 7 but not come into electrical contact with it to avoid shorting the conductor 10 to the feed conductor 12 if they are not insulated from the surface of the RF structure 7.

The radiator 8 has a width W1, for example 110 millimeters. A wider dimension W1 increasing the low band gain of the antenna.

For high band operation, the radiator 8 acts as a ground plane for the dipole elements 17, interfering with high band RF radiation in a direction towards the base plate 2, creating a directional radiation pattern. To minimize high band RF passage through the slot 20 area, the slot 20 may be dimensioned to be, for example, less than 2% of the high band wavelength.

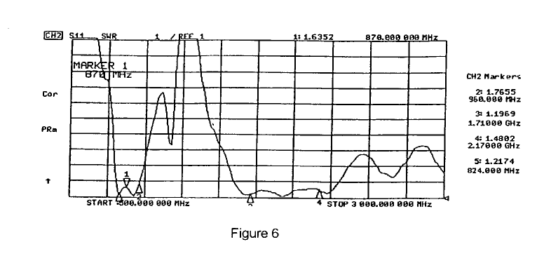

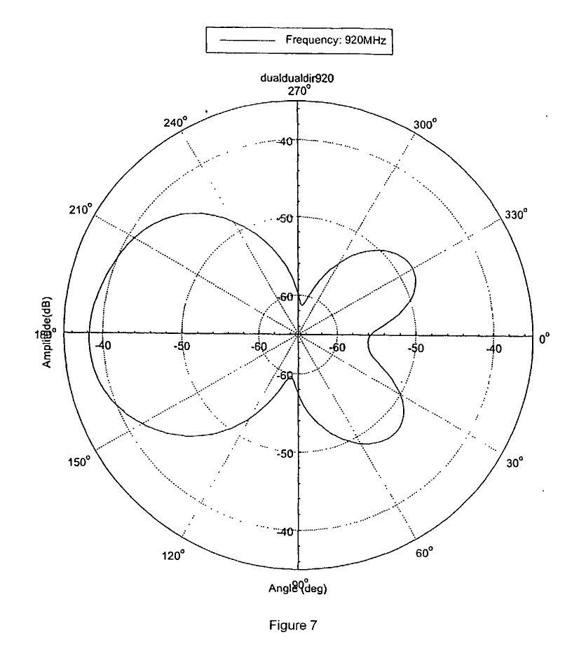

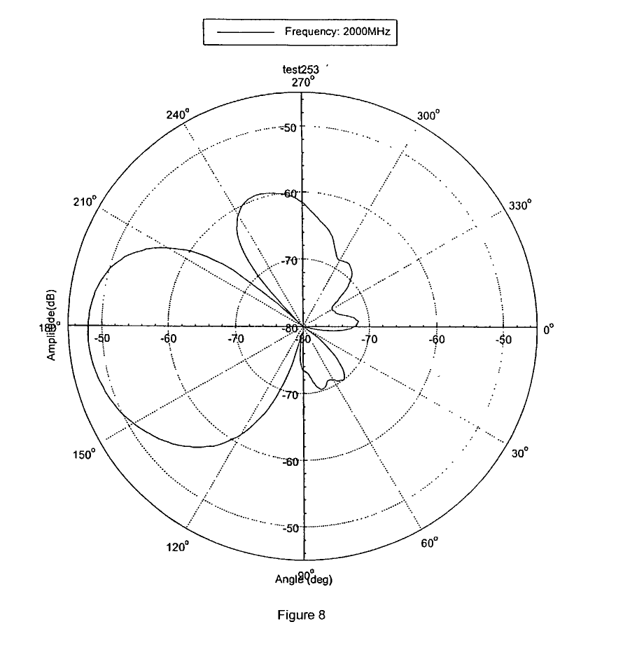

As shown by FIG. 6, the antenna may be configured for operation with standing wave ratios of less than 1.8 in both high and low bands. FIGS. 7 and 8 show that the antenna is directional at both high and low bands.

As described, the dual band directional antenna provides the following advantages. The antenna may be formed from only three elements: a ground plane/baseplate, a radiator and a single component RF structure. The minimal number of elements used to form the antenna reduces manufacturing and materials costs. The antenna is directional when operated at either band, making it desirable where the desired antenna radiation area is well defined, for example in buildings, tunnels and other areas where RF signals are weak or blocked.

Use of printed circuit technology permits tuning of the antenna to new and or different frequency bands without requiring an overall redesign of the baseplate and or cover. Printed circuit technology also decreases component costs and increases final manufacturing assembly efficiency.

Table of Parts

| | |
|---|---|
| 1 | cover |
| 2 | base plate |
| 3 | gasket |
| 4 | screw |
| 5 | washer |
| 6 | angle plate |
| 7 | RF structure |
| 8 | radiator |
| 9 | spacer |
| 10 | conductor |
| 11 | connector |
| 12 | feed conductor |
| 13 | L-probe |
| 14 | matching section |
| 15 | balun |
| 16 | junction |
| 17 | dipole elements |
| 18 | slot |

Where in the foregoing description reference has been made to ratios, integers or components having known equivalents then such equivalents are herein incorporated as if individually set forth.

While the present invention has been illustrated by the description of the embodiments thereof, and while the embodiments have been described in considerable detail, it is not the intention if the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant“s general inventive concept. Further, it is to be appreciated that improvements and/or modifications may be made thereto without departing from the scope or spirit of the present invention as defined by the following claims.

1. An antenna, comprising:
a base plate;
a radiator having an opening, the radiator located in a substantially parallel orientation with and electrically isolated from the base plate and the RF structure;
a RF structure having a dipole portion, the RF structure coupled with the base plate and extending through the opening.

2. The antenna of claim 1, wherein the RF structure has a coupling conductor;
the coupling conductor coupled to an end fed first radiating conductor and an end fed second radiating conductor in the dipole portion;
the first radiating conductor and the second radiating conductor disposed in a end-fed-to-end-fed substantially co-linear orientation, substantially parallel to the radiator; and
the coupling conductor coupled with the base plate.

3. The antenna of claim 2, wherein the dipole antenna has a ½ wavelength dimension across the first and second radiating conductors.

4. The antenna of claim 2, wherein the RF structure has a feed conductor;
the feed conductor coupled to an L-portion arranged proximate the radiator and a matching section.

5. The antenna of claim 4, wherein a high frequency RF current sees a first impedance in the matching section and a first higher impedance in the L-portion; and
a low frequency RF current sees a second impedance in the L-section and a second higher impedance in the matching section.

6. The antenna of claim 5, wherein the L-portion and matching section are dimensioned so that a low frequency RF current is directed to the L-portion and a high frequency RF current is directed to the matching section.

7. The antenna of claim 4, wherein the matching section is coupled with a balun feeding the first radiating conductor and the second radiating conductor.

8. The antenna of claim 7, wherein the balun has a ¼ wavelength dimension.

9. The antenna of claim 4, wherein the conductor is located on a first side of the RF structure and the feed conductor is located on a second side of the RF structure.

10. The antenna of claim 9, wherein the RF structure is a printed circuit board and the feed conductor and the conductor are conductive traces on the printed circuit board.

11. The antenna of claim 9, wherein an antenna feed connector is coupled with the RF structure, contacting the feed conductor and the conductor.

12. The antenna of claim 1, wherein the radiator has a ½ wavelength dimension; and
the opening is a slot oriented parallel to the 12 wavelength dimension.

13. The antenna of claim 1, further including a cover; the cover mating with the base plate to enclose the RF structure and the radiator.

14. The antenna of claim 13, wherein the cover is formed out of plastic.

15. The antenna of claim 13, further including a gasket located between the cover and the base plate.

16. The antenna of claim 13, wherein the cover is attached to the base plate with one of a snap fit, an adhesive and a mechanical fastener.

17. The antenna of claim 1, wherein the radiator is formed out of metal.

18. The antenna of claim 1, wherein the radiator is a conductive trace on an insulating substrate.

19. The antenna of claim 1, wherein at least one dielectric spacer coupled with the base plate supports the radiator.

20. The antenna of claim 1, wherein the base plate is formed out of metal.

21. The antenna of claim 1, wherein the base plate is a conductive trace on an insulating substrate.

22. The antenna of claim 1, wherein the radiator operates in a TM10 mode.

23. The antenna of claim 2, wherein the opening has a slot width less than 2% of a wavelength radiated by the first and second radiating conductors.

24. A dual band antenna, comprising:
a dipole antenna;
a patch antenna;
a base plate; and
a RF feed structure feeding the dipole antenna and the patch antenna;
the dipole antenna coupled to the base plate, mounted at an angle to the base plate;
the patch antenna having an opening through which the dipole antenna projects;
the patch antenna located in a substantially parallel orientation with respect to the base plate.

25. The antenna of claim 24, wherein the dipole antenna and the RF feed structure is an insulating substrate with conductive traces thereon.

26. The antenna of claim 24, wherein the RF feed structure has a L-probe and a matching section.

27. The antenna of claim 26, wherein a high frequency RF current sees a first impedance in the matching section and a higher impedance in the L-portion; and
a low frequency RF current sees a second impedance in the L-section and a higher impedance in the matching section.

28. The antenna of claim 27, wherein the RF feed structure is dimensioned so that a low frequency RF current is directed to the L-portion and a high frequency RF current is directed to the matching section.

29. The antenna of claim 26, wherein the matching section is coupled with a balun feeding the first radiating conductor and the second radiating conductor.

30. The antenna of claim 29, wherein the balun has a ¼ wavelength dimension.

31. The antenna of claim 26, wherein the dipole antenna is located on a first side of the RF feed structure and the L-probe and matching section is located on a second side of the RF feed structure.

32. The antenna of claim 31, wherein an antenna feed connector is mounted on the RF feed structure; the feed connector coupled with the L-probe and the matching section, and the dipole antenna.

33. The antenna of claim 24, wherein the patch antenna has a ½ wavelength dimension; and
the opening is a slot oriented parallel to the ½ wavelength dimension.

34. The antenna of claim 24, further including a cover; the cover mating with the base plate to enclose the RF structure and the radiator.

35. The antenna of claim 34, wherein the cover is formed out of plastic.

36. The antenna of claim 34, further including a gasket located between the cover and the base plate.

37. The antenna of claim 34, wherein the cover is attached to the base plate with one of a snap fit, an adhesive and a mechanical fastener.

38. The antenna of claim 24, wherein the patch antenna is formed out of metal.

39. The antenna of claim 24, wherein the patch antenna is a conductive trace on an insulating substrate.

40. The antenna of claim 24, wherein at least one dielectric spacer coupled with the base plate supports the patch antenna.

41. The antenna of claim 24, wherein the base plate is formed out of metal.

42. The antenna of claim 24, wherein the base plate is a conductive trace on an insulating substrate.

43. The antenna of claim 24, wherein the patch antenna operates in a TM10 mode.

44. The antenna of claim 24, wherein the opening has a slot width less than 2% of a wavelength radiated by the dipole antenna.

45. A dual band antenna, comprising:
a dipole antenna;
a patch antenna;
a base plate; and
the dipole antenna and the patch antenna arranged so that the patch antenna acts as a ground plane for the dipole antenna, whereby a directivity of the dipole antenna is increased.

46. A dual band antenna, comprising:
a dipole antenna;
a patch antenna; and
a RF structure;
the RF structure having a band discriminating impedance match whereby a high frequency RF current sees a first impedance in a dipole antenna section and a higher impedance in a patch antenna section; and
a low frequency RF current sees a second impedance in the patch antenna section and a higher impedance in the dipole antenna section.

47. A dual band antenna, comprising:
a dipole antenna;
a patch antenna; and
an antenna feed coupled to the dipole antenna and the patch antenna;
the antenna feed directing a majority of a high frequency RF current to the dipole antenna section and a majority of a low frequency RF current to the patch antenna.
